(19) United States
(12) Patent Application Publication
(10) Pub. No.: US 2012/0311317 A1
(43) Pub. Date: Dec. 6, 2012

(54) Access-controlled customer data offloading to blind public utility-managed device

(76) Inventors: David Elrod, Beaverton, OR (US); Daniel J. Park, Beaverton, OR (US); James E. Owen, Vancouver, WA (US)

(21) Appl. No.: 13/134,236

(22) Filed: Jun. 2, 2011

(51) Int. Cl. H04L 9/00

(52) U.S. Cl. 713/150

(57) ABSTRACT

A method and system for access-controlled customer data offloading uses a blind public utility-managed device. A customer-managed device encrypts collected customer data using per-type, per-period keys and transmits the encrypted customer data to the utility-managed device. The customer-managed device further encrypts the per-type, per-period keys using a master key and transmits the encrypted per-type, per-period keys to the utility-managed device. When the current period ends (e.g., each day at midnight), the customer-managed device generates new per-type, per-period keys and continues the above customer data offloading using the new per-type, per-period keys. As a result, the customer offloads storage of customer data to the public utility without relinquishing control over access to the customer data. Moreover, the fact that the customer data are encrypted by data type and period allows the customer to access and expose the customer data in highly granular fashion.

### BACKGROUND OF THE INVENTION

The present invention relates to energy management systems and, more particularly, to privacy and storage of customer data within energy management systems.

Energy management systems operated by public utilities collect customer data from home energy management system (HEMS) devices and smart meters at customer premises. The public utilities apply the customer data to various purposes, such as determining demand response (DR) and time-of-use incentives and controls and diagnosing power outages.

Many customers are unhappy with the steady leaking of their information to public utilities. Concerns range from general loss of privacy to the potential for unwanted use or misuse of customer data, such as by a burglar who might acquire the customer data and infer from low electricity use that the customer is away from home, a law enforcement agency that might infer from electricity usage patterns that the customer is engaged in criminal activity, or a health or insurance company that might infer from high nighttime electricity use that the customer has a sleep disorder.

One way to address these customer concerns is to accumulate customer data on the HEMS device or smart meter and transmit the customer data only after a substantial delay, and in decimated form. The access delay reduces the potential for certain abuses of the customer data (e.g., by a burglar) and decimation reduces the potential for all types of abuses. However, the delay-and-decimate approach requires a HEMS device or smart meter with large storage capacity and processing power.

### SUMMARY OF THE INVENTION

The present invention provides access-controlled customer data offloading using a blind public utility-managed device. A customer-managed device, such as a HEMS device or a smart meter, sorts collected customer data by data type and encrypts the customer data using per-type, per-period encryption keys. The customer-managed device transmits the encrypted customer data to the utility-managed device whereon the encrypted customer data are stored. The customer-managed device further encrypts the per-type, per-period keys using a master encryption key and transmits the encrypted per-type, per-period keys to the utility-managed device whereon the encrypted per-type, per-period keys are stored. When the current period ends (e.g., each day at midnight), the customer-managed device generates new per-type, per-period encryption keys and continues the above customer data offloading using the new per-type, per-period keys. As a result of this continual encrypt-and-offload process, the customer offloads storage of customer data to the public utility without relinquishing control over access to the customer data. Moreover, the fact that the customer data are encrypted in small “chunks” by data type and period allows the customer to access and expose the customer data in highly granular fashion. For example, once electric car data are thirty days old, the customer-managed device can reacquire from the utility-managed device the encrypted electric car key in use thirty days ago, decrypt the electric car key using the master key, and transmit the decrypted electric car key to the utility-managed device, exposing the 30-day old electric car data to the public utility without exposing any of the customer's other data. Furthermore, the customer can replace the customer-managed device without loss of historical customer data by simply transferring the master key to the replacement customer-managed device.

In one aspect of the invention, a customer data access control method comprises the steps of acquiring by a customer-managed device customer data; encrypting by the customer-managed device the customer data using first per-type, per-period encryption keys; and transmitting by the customer-managed device to a public utility-managed device the encrypted customer data.

In some embodiments, the method further comprises the steps of encrypting by the customer-managed device the first per-type, per-period keys using a master encryption key; and transmitting by the customer-managed device to the utility-managed device the encrypted first per-type, per-period keys.

In some embodiments, the method further comprises the steps of reacquiring by the customer-managed device from the utility-managed device one or more of the encrypted first per-type, per-period keys used to encrypt first data within the encrypted customer data; decrypting by the customer-managed device the reacquired keys using the master key; and transmitting by the customer-managed device to the utility-managed device the decrypted keys.

In some embodiments, the method further comprises the steps of reacquiring by the customer-managed device from the utility-managed device encrypted first data within the encrypted customer data; reacquiring by the customer-managed device from the utility-managed device one or more of the encrypted first per-type, per-period keys used to encrypt the first data; decrypting by the customer-managed device the reacquired keys using the master key; and decrypting by the customer-managed device the encrypted first data using the decrypted keys.

In some embodiments, the method further comprises the steps of generating by the customer-managed device a summary of the decrypted first data; and transmitting by the customer-managed device to the utility-managed device the summary.

In some embodiments, the method further comprises the steps of reacquiring by the customer-managed device from the utility-managed device one or more of the encrypted first per-type, per-period keys used to encrypt first data within the encrypted customer data; decrypting by the customer-managed device the reacquired keys using the master key; decrypting by the customer-managed device the first data using the reacquired keys; reencrypting by the customer-managed device the first data using a public key of a third party; and transmitting by the customer-managed device to a third party-managed device the reencrypted first data.

In some embodiments, the method further comprises the steps of encrypting by the customer-managed device the master key; transmitting by the customer-managed device to the utility-managed device the encrypted master key; reacquiring by a remote customer-managed device from the utility-managed device the encrypted master key; and decrypting by the remote customer-managed device the encrypted master key using a customer credential.

In some embodiments, the method further comprises the step of replacing by the customer-managed device the first per-type, per-period keys with second per-data type, per-period encryption keys in response to a transition from a first time period to a second time period.

In some embodiments, at least one of the first per-type, per-period keys encrypts usage data for a specific appliance over a specific time period.

In some embodiments, at least one of the first per-type, per-period keys encrypts customer data of a specific measurement type over a specific time period.

In some embodiments, at least one of the first per-type, per-period keys encrypts customer data for a specific area over a specific time period.

In another aspect of the invention, a customer-managed device comprises at least one local interface; at least one remote interface; at least one memory; and at least one processor communicatively coupled with the local interface, remote interface and memory, wherein the customer-managed device acquires customer data via the local interface, under control of the processor encrypts the customer data using first per-type, per-period encryption keys retrieved from the memory and transmits to a public utility-managed device the encrypted customer data via the remote interface.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows an energy management system in some embodiments of the invention.

FIG. 2 shows a customer-managed device in some embodiments of the invention.

FIG. 3 shows a method performed by a customer-managed device for offloading encrypted per-type, per-period customer data and encryption keys to a public utility-managed device in some embodiments of the invention.

FIG. 4 shows a method performed by a customer-managed device for exposing encrypted per-type, per-period customer data to a public utility-managed device in some embodiments of the invention.

FIG. 5 shows a method performed by a customer-managed device for providing a summary of encrypted per-type, per-period customer data to a public utility-managed device in some embodiments of the invention.

FIG. 6 shows a method performed by a customer-managed device for exposing encrypted per-type, per-period customer data to a third party-managed device in some embodiments of the invention.

FIG. 7 shows a method for accessing encrypted per-type, per-period customer data using a remote customer I/O device in some embodiments of the invention.

### DETAILED DESCRIPTION OF A PREFERRED EMBODIMENT

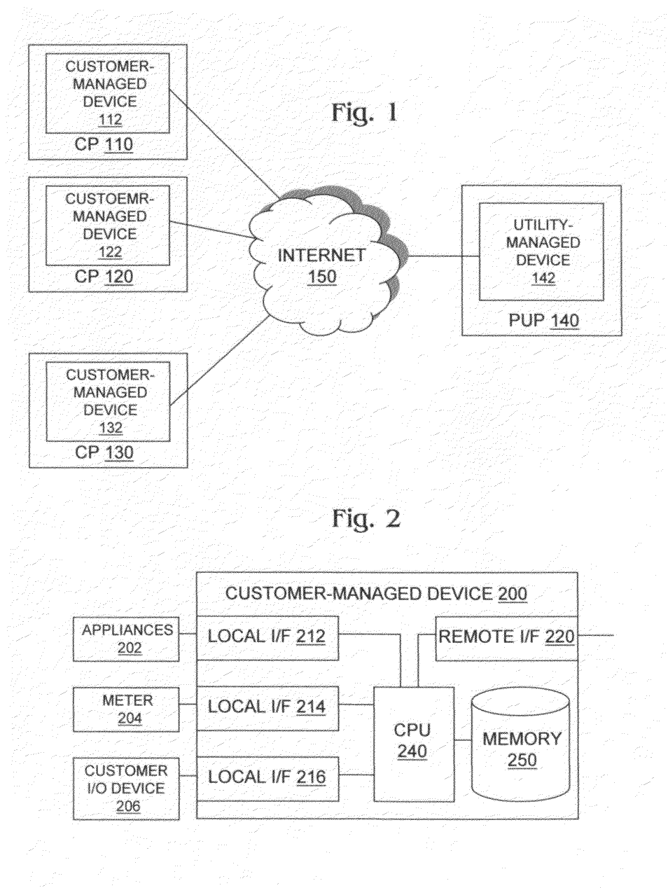

FIG. 1 shows an energy management system in some embodiments of the invention. The energy management system includes a multiple of customer-managed devices 112, 122, 132, resident at respective customer premises (CP) 110, 120, 130. Customer premises 110, 120, 130 may be, for example, commercial premises such as shops and business offices or residential premises such as homes, condominiums and apartments. The energy management system also includes a public utility-managed device 142 resident at a public utility premises 140. Customer-managed devices 112, 122, 132 are interconnected with utility-managed device 142 over the Internet 150. Customer-managed devices 112, 122, 132 and utility-managed device 142 communicate using standard communication protocols, such as the Internet Protocol (IP). As part of this communication, customer-managed devices 112, 122, 132 continually transmit to utility-managed device 142 encrypted per-type, per-period customer data for customer premises 110, 120, 130 and encrypted per-type, per-period encryption keys for customer premises 110, 120, 130. Customer-managed devices 112, 122, 132 thereafter, on a selective basis, access the encrypted customer data and keys, expose the customer data and/or provide summaries of the customer data. While the energy management system is shown to include three customer-managed devices 112, 122, 132 resident at respective customer premises 110, 120, 130, the number of customer-managed nodes and customer premises within an energy management system may vary and will often be much larger (e.g., 1000 homes). Moreover, while customer-managed devices 112, 122, 132 are shown and described as being resident at respective customer premises 110, 120, 130, customer-managed devices 112, 122, 132 in other embodiments may remotely manage their respective customer premises 110, 120, 130 from an off-site location. Similarly, while utility-managed device 142 is described as being resident at public utility premises (PUP) 140, utility-managed device 142 in other embodiments may reside at an off-site location.

FIG. 2 shows a customer-managed device 200, which is representative of customer-managed devices 112, 122, 132, in some embodiments of the invention. Customer-managed device 200 has a processor 240 communicatively coupled between a multiple of local interfaces 212, 214, 216 and a remote interface 220. Processor 240 is also communicatively coupled with a memory 250. In some embodiments, processor 240 is a microprocessor that performs operations attributed to processor 240 herein by executing software instructions stored in memory 250. In other embodiments, operations attributed to processor 240 herein may be carried out in part or in whole in custom logic. Electrical appliances 202 are interconnected to customer-managed device 200 via local interface 212. Electrical appliances 202 may include, for example, a thermostat, washer, dryer, computer, hot tub, electric car, inverter and/or solar panel. An electricity meter 204 is interconnected to customer-managed device 200 via local interface 214. A customer input/output (I/O) device 206 is interconnected to customer-managed device 200 via local interface 216. Customer I/O device 206 may be, for example, a desktop, notebook, netbook or tablet computer, a smart phone, an Internet appliance or a peripheral I/O device such as a keyboard, keypad or touch screen. The local connections between elements 202, 204, 206 and customer-managed device 200 may include wired connections (e.g., wired Ethernet) and/or wireless connections (e.g., Wi-Fi, ZigBee, Bluetooth). Customer-managed device 200 is interconnected to utility-managed device 142 over the Internet 150 via remote interface 220. While for simplicity appliances 202 are shown interconnected to one local interface 212, electrical appliances may be interconnected to more than one local interface of customer-managed device 200. Moreover, in some embodiments one or more electrical appliances and/or electricity meter may be integral to the customer-managed device.

Appliances 202 and electricity meter 204 continually transmit locally formatted customer data to customer-managed device 200 via local interfaces 212, 214, respectively. By way of example, appliance 202 may transmit charge data for an electric car to customer-managed device 200 and electricity meter 204 may transmit meter readings for the customer premises to customer-managed device 200.

Customer I/O device 206 transmits configuration information to customer-managed device 200 via local interface 216. The customer defines through inputs on customer I/O device 206 data types and key periods. A data type may address, by way of example, a specific appliance, a specific area, a specific measurement type (e.g., watts, volts, power factor, temperature, etc.), or a specific sum or average of customer data. A key period may last, by way of example, a minute, an hour, a day, a week or a month. A customer who has little concern about data privacy may define a single data type and a key period of one month. In that case, customer-managed device 200 generates and uses one per-period encryption key to encrypt all customer data collected by customer-managed device 200 and changes the per-period key only once a month. On the other hand, a customer who has a great concern about data privacy may define dozens of data types and a key period of one hour. In that case, customer-managed device 200 generates and uses dozens of different per-period encryption keys to encrypt different types of customer data collected by customer-managed device 200 and changes these dozens of per-type, per-period keys on an hourly basis. The customer also defines through inputs on customer I/O device 206 time delays for exposing and/or providing summaries of different data types to the public utility and/or third parties. For example, the customer may define that electric car data be exposed to utility-managed device 142 after a 30-day delay and that a summary of lighting data be provided to utility-managed device 142 after a 90-day delay. Customer-managed device 200 under the control of processor 240 stores in memory 250 and applies data type, key period and time delay definitions and per-type, per-period encryption keys. Customer-managed device 200 under the control of processor 240 also store in memory a master encryption key. The per-type, per-period keys may be 128-bit keys and the master key may be a 2048 bit key, by way of example.

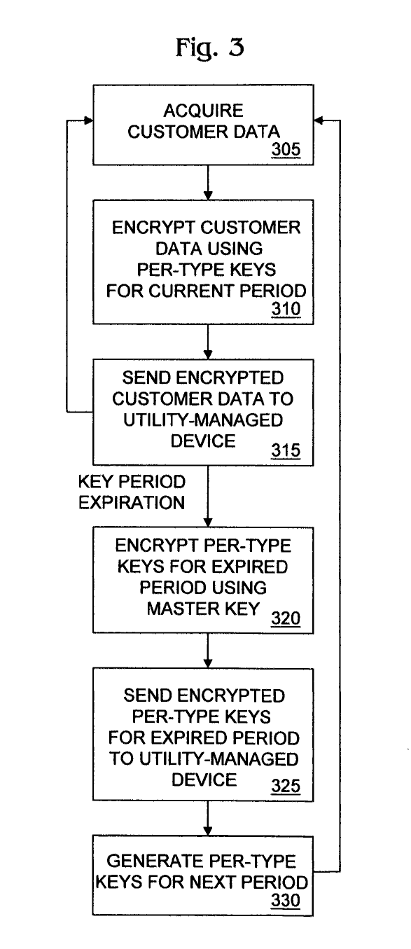

FIG. 3 shows a method performed by customer-managed device 200 for offloading encrypted per-type, per-period customer data and encryption keys to utility-managed device 142 in some embodiments of the invention. Customer-managed device 200 acquires locally formatted customer data for the current period from appliances 202 and electricity meter 204 via local interfaces 212, 214, respectively (305). Customer-managed device 200 under the control of processor 240 converts the customer data into a format expected by utility-managed device 142 and temporarily stores the customer data in memory 250, sorted by data type. Customer data relative to each data type and period defined by the customer are physically or logically segregated in memory 250.

Next, customer-managed device 200 under the control of processor 240 encrypts the customer data for the current period by data type using the per-type encryption keys for the current period (310). The per-type keys for the current period are retrieved from memory 250 and are used to encrypt the customer data by data type.

Next, customer-managed device 200 sends the encrypted customer data for the current period to utility-managed device 142 via remote interface 220 (315), whereupon the encrypted customer data for the current period becomes stored on utility-managed device 142. Once receipt of the encrypted customer data has been acknowledged by utility-managed device 142, copies of the customer data may be removed from memory 250 or allowed to be overwritten in memory 250.

If by that point the key period defined by the customer through inputs on customer I/O device 206 has not expired (e.g., midnight has not yet arrived), there is more time for customer data acquisition and transfer within the current period and the method reverts to Step 305 for additional current-period customer data acquisition. If, however, the key period has expired (e.g., midnight has arrived), no more time remains for customer data acquisition and transfer within the current period. Accordingly, customer-managed device 200 under the control of processor 240 encrypts the per-type keys for the expired period using a master encryption key (320). The per-type keys for the expired period and the master key are retrieved from memory 250 and the master key is used to encrypt the per-type keys for the expired period.

Next, customer-managed device 200 sends the encrypted per-type keys for the expired period to utility-managed device 142 via remote interface 220 (325), whereupon the encrypted per-type keys for the expired period become stored on utility-managed device 142. Once receipt of the encrypted per-type keys have been acknowledged by utility-managed device 142, copies of the per-type keys may be removed or allowed to be freely overwritten from memory 250.

In some embodiments, customer-managed device 200 encrypts and sends the per-type keys to utility-managed device 142 at the beginning of their period of use rather than after expiration. That way, if customer-managed device 200 experiences a fatal crash during the period, encrypted customer data sent to utility-managed device 142 during the period before the crash can be recovered.

At that point, customer-managed device 200 under the control of processor 240 generates per-type encryption keys for the next period (330) and the method reverts to Step 305 for customer data acquisition in the next period.

In some embodiments, the encrypted customer data for the expired period are sent to and stored on a remote storage device other than utility-managed device 142 (e.g., cloud storage) that is accessible to utility-managed device 142.

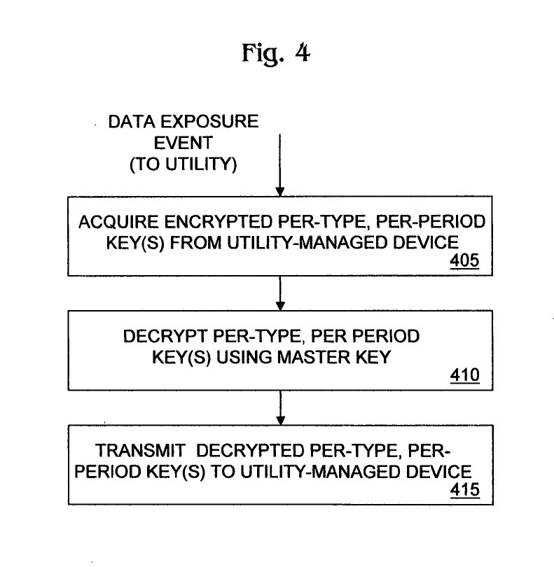

FIG. 4 shows a method performed by customer-managed device 200 for exposing encrypted per-type, per-period customer data to utility-managed device 142 in some embodiments of the invention. This method enables the customer to expose to the public utility selected customer data remotely stored in accordance with the method FIG. 3 at a time selected by the customer. At the outset, customer-managed device 200 under the control of processor 240 detects a data exposure event relative to the public utility. In some embodiments, a data exposure event relative to the public utility is detected when customer-managed device 200 determines that a scheduled time has arrived for exposure to a public utility. The scheduled exposure time may be configured in response to an input by the customer on customer I/O system 206 or in response to a paid or unpaid data exposure agreement made between the customer and the public utility. For example, customer-managed device 200 may be programmed at midnight every night to expose to utility-managed node 142 30-day-old electric car usage data collected by customer-managed device 200. In other embodiments, a data exposure event is detected upon acceptance by customer-managed device 200 of a special request to expose data issued by utility-managed node 142 and received via remote interface 220. For example, if an unplanned blackout occurred three days ago, customer-managed device 200 may receive and accept a special request issued by utility-managed node 142 to expose all customer data from that day to assist the public utility in evaluating the cause of the blackout.

In response to a data exposure event, customer-managed device 200 under the control of processor 240 reacquires from utility-managed device 142 via remote interface 220 the encrypted per-type, per-period encryption key or keys associated with the data exposure event (405). For example, if the data exposure event calls for exposing 30-day-old electric car usage data, customer-managed device 200 reacquires from utility-managed device 142 the encrypted electric car key that was used by customer-managed node 200 30 days ago to encrypt electric car data.

Next, customer-managed device 200 under the control of processor 240 decrypts the encrypted per-type, per-period encryption key or keys associated with the data exposure event using the master encryption key (410). The master key is retrieved from memory 250 and used to decrypt the per-type key or keys.

Next, customer-managed device 200 sends to utility-managed device 142 via remote interface 220 the decrypted per-type, per-period encryption key or keys associated with the data exposure event (415), whereupon the decrypted per-type, per-period key or keys associated with the data exposure event are available for use by utility-managed device 142 to decrypt and use the per-type, per-period customer data associated with the data exposure event. Where the encrypted customer data are stored on a remote storage device other than utility-managed device 142 (e.g., cloud storage), utility-managed device 142 may prevent the per-type, per-period key or keys from becoming further exposed by acquiring the customer data from the remote storage device in encrypted form and decrypting the customer data on utility-managed device 142.

Once receipt of the encrypted per-type key or keys associated with the data exposure event has been acknowledged by utility-managed device 142, all copies of these per-type, per-period keys are removed or allowed to be freely overwritten from memory 250.

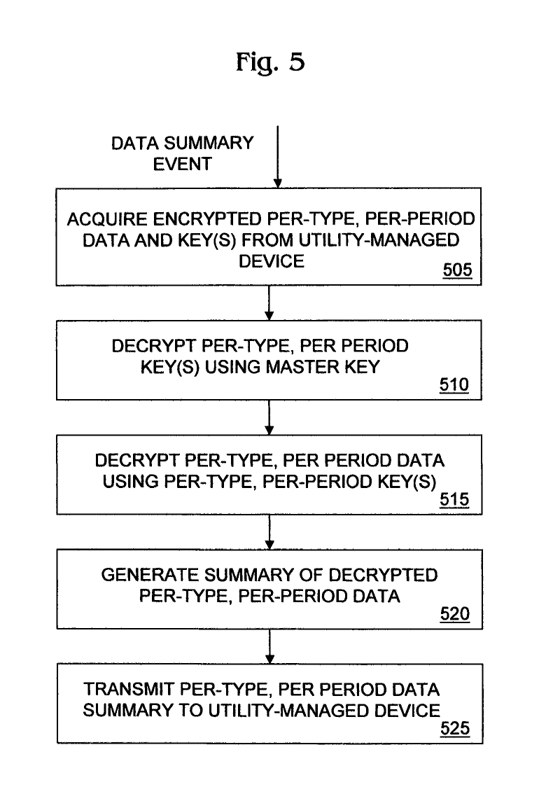

FIG. 5 shows a method performed by customer-managed device 200 for providing a summary of encrypted per-type, per-period customer data to utility-managed device 142 in some embodiments of the invention. This method enables a customer to even more tightly control access to customer data remotely stored in accordance with the method of FIG. 3 by releasing summaries of selected customer data rather than exposing the customer data itself. At the outset, customer-managed device 200 under the control of processor 240 detects a data summary event. In some embodiments, a data summary event is detected when customer-managed device 200 determines that a scheduled summary time inputted by the customer on customer I/O system 206 has arrived. For example, customer-managed device 200 may be programmed at midnight every night to provide a summary to utility-managed node 142 of 90-day-old lighting data collected by customer-managed device 200. In other embodiments, a data summary event is detected upon acceptance by customer-managed device 200 of a request to provide a data summary issued by utility-managed node 142 and received via remote interface 220.

Next, In response to a data summary event, customer-managed device 200 under the control of processor 240 reacquires via remote interface 220 the encrypted per-type, per-period customer data and per-type, per-period encryption key or keys associated with the data summary event (505). For example, if the data summary event calls for providing a summary of 90-day-old lighting data, customer-managed device 200 reacquires from utility-managed node 142 encrypted lighting data that was collected 90 days ago and the lighting key that was used by customer-managed node 200 90 days ago to encrypt the lighting data.

Next, customer-managed device 200 under the control of processor 240 decrypts the per-type, per-period encryption key or keys associated with the data summary event using the master encryption key (510). The master key is retrieved from memory 250 and used to decrypt the per-type key or keys.

Next, customer-managed device 200 under the control of processor 240 decrypts the per-type, per-period customer data associated with the data summary event using the decrypted per-type, per-period encryption key or keys associated with the data summary event (515).

Next, customer-managed device 200 under the control of processor 240 generates a summary of the per-type, per-period customer data (520). Contents of the summary may be selected by the customer through inputs on customer I/O system 206 and convey useful information to the public utility without divulging details that the customer regards as invasive of privacy.

Next, customer-managed device 200 sends to utility-managed device 142 via remote interface 220 the per-type, per-period summary (525), whereupon the summary is available for use by utility-managed device 142.

Once receipt of the summary has been acknowledged by utility-managed device 142, all copies of the per-type, per-period customer data and keys associated with the data summary event may be removed or allowed to be freely overwritten from memory 250.

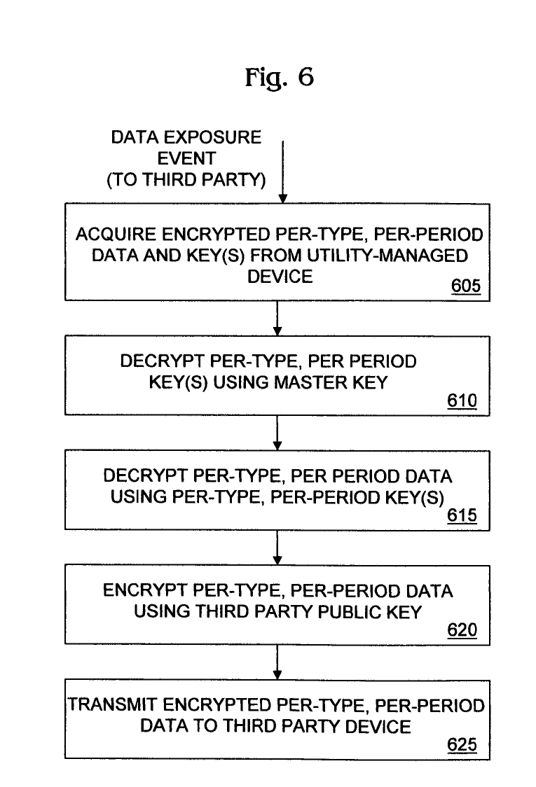

FIG. 6 shows a method performed by customer-managed device 200 for exposing encrypted per-type, per-period customer data to a third party-managed device in some embodiments of the invention. This method enables the customer to expose to a third party (i.e., a party other than the public utility) selected customer data remotely stored in accordance with the method FIG. 3 at a time selected by the customer. At the outset, customer-managed device 200 under the control of processor 240 detects a data exposure event relative to a third party. In some embodiments, a data exposure event relative to a third party is detected when customer-managed device 200 determines that a scheduled time has arrived for exposure to the third party. The scheduled exposure time may be configured in response to an input by the customer on customer I/O system 206 or a paid or unpaid data exposure agreement made between the customer and the third party. For example, customer-managed device 200 may be programmed at midnight every night to expose to a device managed by an electric car manufacturer 30-day-old electric car data collected by customer-managed device 200. In other embodiments, a data exposure event is detected upon acceptance by customer-managed device 200 of a special request to expose data issued by the third party device and received via remote interface 220.

Next, In response to a data exposure event, customer-managed device 200 under the control of processor 240 reacquires via remote interface 220 the encrypted per-type, per-period customer data and per-type, per-period encryption key or keys associated with the third party data exposure event (605). For example, if the data exposure event calls for providing a summary of 30-day old electric car data, customer-managed device 200 reacquires from utility-managed node 142 encrypted electric car data that was collected 30 days ago and the electric car key that was used by customer-managed node 200 30 days ago to encrypt the electric car data.

Next, customer-managed device 200 under the control of processor 240 decrypts the per-type, per-period encryption key or keys associated with the data exposure event using the master encryption key (610). The master key is retrieved from memory 250 and used to decrypt the per-type key or keys.

Next, customer-managed device 200 under the control of processor 240 decrypts the per-type, per-period customer data associated with the data exposure event using the decrypted per-type, per-period encryption key or keys associated with the data exposure event (615).

Next, customer-managed device 200 under the control of processor 240 reencrypts the per-type, per-period customer data associated with the data exposure event using the third party's public encryption key (620).

Next, customer-managed device 200 sends the reencrypted per-type, per-period customer data associated with the data exposure event to the device managed by the third party (625). Upon receipt, the third party-managed device decrypts the per-type, per-period customer data using the third party's private encryption key, whereupon the customer data are available for use by the third party.

In other embodiments, customer-managed device 200 encrypts the per-type, per-period customer data associated with a data exposure event with a symmetrical encryption key, encrypts the symmetrical key using the third party's public key, and transmits the encrypted customer data and symmetrical key to the device managed by the third party. Upon receipt, the third party-managed device decrypts the symmetrical key using the third party's private key and uses the symmetrical key to decrypt the per-type, per-period customer data, whereupon the customer data are available for use by the third party.

In still other embodiments, customer-managed device 200 sends the per-type, per-period customer data associated with a data exposure event to the device managed by the third party in unencrypted form.

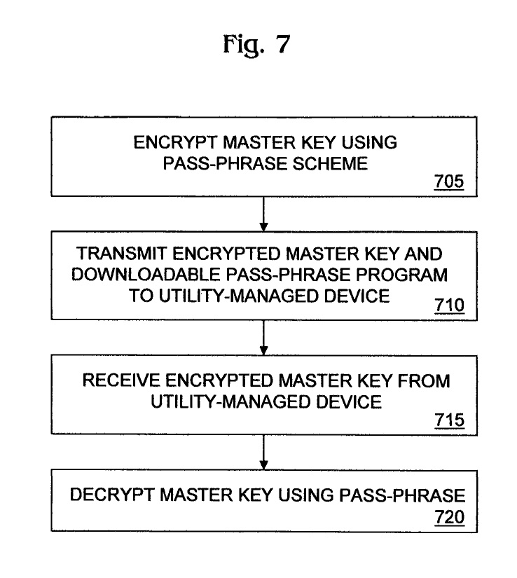

FIG. 7 shows a method for accessing encrypted per-type, per-period customer data from a remote customer I/O device in some embodiments of the invention. The method of FIG. 7 provides a means for the customer to access the master encryption key needed to decrypt the per-type, per-period encryption keys for the customer data from a remote customer I/O device. At the outset, customer-managed device 200 encrypts the master encryption key using a pass-phrase encryption scheme (705) and sends the master key and a downloadable pass-phrase program (e.g., Java Web Start program) for unlocking the master key to utility-managed device 142 (710), whereon the encrypted master key and downloadable program are stored. From a remote customer I/O device, the customer later acquires the encrypted master key and pass-phrase program from utility-managed device 142 (715), executes the pass-phrase program and decrypts the master key by inputting the correct pass-phrase (720). The remote customer I/O device can then acquire from utility-managed device 142 the encrypted per-type, per-period encryption keys and associated per-type, per-period electricity usage data to be remotely accessed, decrypt the per-type, per-period keys using the decrypted master key, and use the decrypted per-type, per-period keys to decrypt and access the per-type, per-period customer data.

In other embodiments, a customer credential other than a pass-phrase is invoked to encrypt and decrypt the master key.

In other embodiments, the customer I/O device sends the decrypted per-type, per-period keys to utility-managed device 142, which decrypts and returns to the remote customer I/O device the per-type, per-period customer data and then destroys the decrypted per-type, per-period keys.

In still other embodiments, the customer accesses his or her electricity usage data from a remote location by storing a copy of the master key on a Universal Serial Bus (USB) dongle and carrying the dongle with him or her.

In still other embodiments, the per-type, per-period keys are not stored on the utility-managed device. For example, the per-type, per-period keys may be stored on the customer-managed device and sent to the utility-managed device only when needed to decrypt specific customer data. Yet another approach could have the customer-managed device request specific encrypted customer data from the utility-managed device, decrypt the customer data and send the customer data back to the utility-managed device. In this approach, the per-type, per-period keys never leave the customer-managed device.

It will be appreciated by those of ordinary skill in the art that the invention can be embodied in other specific forms without departing from the spirit or essential character hereof. For example, while specific examples have been described in which the customer data relates to electricity usage, the customer data may address other parameters relevant to energy management, such as temperature, occupancy or natural gas usage. The present description is thus considered in all respects to be illustrative and not restrictive. The scope of the invention is indicated by the appended claims, and all changes that come with in the meaning and range of equivalents thereof are intended to be embraced therein.

What is claimed is:

1. A customer data access control method, comprising the steps of:
acquiring by a customer-managed device customer data;
encrypting by the customer-managed device the customer data using first per-type, per-period encryption keys; and
transmitting by the customer-managed device to a public utility-managed device the encrypted customer data.

2. The method of claim 1, further comprising the steps of:
encrypting by the customer-managed device the first per-type, per-period keys using a master encryption key; and
transmitting by the customer-managed device to the utility-managed device the encrypted first per-type, per-period keys.

3. The method of claim 2, further comprising the steps of:
reacquiring by the customer-managed device from the utility-managed device one or more of the encrypted first per-type, per-period keys used to encrypt first data within the encrypted customer data;
decrypting by the customer-managed device the reacquired keys using the master key; and
transmitting by the customer-managed device to the utility-managed device the decrypted keys.

4. The method of claim 2, further comprising the steps of:
reacquiring by the customer-managed device from the utility-managed device encrypted first data within the encrypted customer data;
reacquiring by the customer-managed device from the utility-managed device one or more of the encrypted first per-type, per-period keys used to encrypt the first data;
decrypting by the customer-managed device the reacquired keys using the master key; and
decrypting by the customer-managed device the encrypted first data using the decrypted keys.

5. The method of claim 4, further comprising the steps of:
generating by the customer-managed device a summary of the decrypted first data; and
transmitting by the customer-managed device to the utility-managed device the summary.

6. The method of claim 2, further comprising the steps of:
reacquiring by the customer-managed device from the utility-managed device one or more of the encrypted first per-type, per-period keys used to encrypt first data within the encrypted customer data;
decrypting by the customer-managed device the reacquired keys using the master key;
decrypting by the customer-managed device the first data using the reacquired keys;
reencrypting by the customer-managed device the first data using a public key of a third party; and
transmitting by the customer-managed device to a third party-managed device the reencrypted first data.

7. The method of claim 2, further comprising the steps of:
encrypting by the customer-managed device the master key;
transmitting by the customer-managed device to the utility-managed device the encrypted master key;
reacquiring by a remote customer-managed device from the utility-managed device the encrypted master key; and
decrypting by the remote customer-managed device the encrypted master key using a customer credential.

8. The method of claim 1, further comprising the step of replacing by the customer-managed device the first per-type, per-period keys with second per-data type, per-period encryption keys in response to a transition from a first time period to a second time period.

9. The method of claim 1, wherein at least one of the first per-type, per-period keys encrypts customer data for a specific appliance over a specific time period.

10. The method of claim 1, wherein at least one of the first per-type, per-period keys encrypts customer data of a specific measurement type over a specific time period.

11. The method of claim 1, wherein at least one of the first per-type, per-period keys encrypts customer data for a specific area over a specific time period.

12. A customer-managed device, comprising:
at least one local interface;
at least one remote interface;
at least one memory; and
at least one processor communicatively coupled with the local interface, remote interface and memory, wherein the customer-managed device acquires customer data via the local interface, under control of the processor encrypts the customer data using first per-type, per-period encryption keys retrieved from the memory and transmits to a public utility-managed device the encrypted customer data via the remote interface.

13. The customer-managed device of claim 12, wherein under control of the processor the customer-managed device encrypts the first per-type, per-period keys using a master encryption key, and wherein the customer-managed device transmits to the utility-managed device the encrypted first per-type, per-period keys.

14. The customer-managed device of claim 13, wherein the customer-managed device reacquires from the utility-managed device one or more of the encrypted first per-type, per-period keys used to encrypt first data within the encrypted customer data, wherein under control of the processor the customer-managed device decrypts the reacquired keys using the master key, and wherein the customer-managed device transmits to the utility-managed device the decrypted keys.

15. The customer-managed device of claim 13, wherein the customer-managed device reacquires from the utility-managed device encrypted first data within the encrypted customer data and one or more of the encrypted first per-type, per-period keys used to encrypt the first data, and wherein under control of the processor the customer-managed device decrypts the reacquired keys using the master key and the encrypted first data using the decrypted keys.

16. The customer-managed device of claim 15, wherein under control of the processor the customer-managed device generates a summary of the decrypted first data, and wherein the customer-managed device transmits to the utility-managed device the summary.

17. The customer-managed device of claim 13, wherein the customer-managed device reacquires from the utility-managed device one or more of the encrypted first per-type, per-period keys used to encrypt first data within the encrypted customer data, wherein under control of the processor the customer-managed device decrypts the reacquired keys using the master key and the first data using the reacquired keys, wherein under control of the processor the customer-managed device reencrypts the first data using a public key of a third party, and wherein the customer-managed device transmits to a third party-managed device the reencrypted first data.

18. The customer-managed device of claim 12, wherein under control of the processor the customer-managed device replaces the first per-type, per-period keys with second per-data type, per-period encryption keys in response to a transition from a first time period to a second time period.

19. The customer-managed device of claim 12, wherein at least one of the first per-type, per-period keys encrypts customer data for a specific appliance over a specific time period.

20. The customer-managed device of claim 12, wherein at least one of the first per-type, per-period keys encrypts customer data for a specific area over a specific time period.
